(19) United States
(12) Patent Application Publication
(10) Pub. No.: US 2023/0085873 A1
(43) Pub. Date: Mar. 23, 2023

(54) METHOD AND SYSTEM FOR PUBLISHING PATENT DATA, AND PATENT TRADING PLATFORM

(71) Applicant: CHINA SOUTHERN POWER GRID RESEARCH INSTITUTE CO., LTD, Guangzhou, Guangdong (CN)

(72) Inventors: Jin ZHENG, Guangzhou (CN); Yongjun LIU, Guangzhou (CN); Guangkai LI, Guangzhou (CN); Qinghong WANG, Guangzhou (CN); Sen ZENG, Guangzhou (CN); Zhixue LIU, Guangzhou (CN); Chunjie ZHEN, Baoding (CN)

(73) Assignee: CHINA SOUTHERN POWER GRID RESEARCH INSTITUTE CO., LTD, Guangzhou, Guangdong (CN)

(21) Appl. No.: 17/789,727

(22) PCT Filed: Jul. 2, 2020
(86) PCT No.: PCT/CN2020/099989

§ 371 Date: Jun. 28, 2022

(30) Foreign Application Priority Data
Dec. 28, 2019 (CN) 201911384398.2

(51) Int. Cl. G06F 16/383; G06Q 30/02; G06Q 40/04

(52) U.S. Cl. CPC G06F 16/383; G06Q 30/0206; G06Q 40/04

(57) ABSTRACT

A method and system for publishing patent data, and a patent trading platform. The method includes the following steps: providing at least one description item information of a patent to be traded: obtaining and checking all description item information and legal status information of said patent according to the at least one description item information; obtaining a transaction price of said patent; and publishing the transaction price, all the description item information and the legal status information. According to the method for publishing patent data, all description item information and legal status information can be automatically obtained and checked after at least one description item information is input, so as to avoid the problem of wrong entry of patent information.

### TECHNICAL FIELD

The present disclosure relates to the field of communications, and in particular to a patent data publishing method and system, and a patent transaction platform.

### BACKGROUND

In China, with the increase in the number of patent applications and the strengthening of patent protection awareness, many Internet-based patent operation platforms are emerging on the market. Patent sellers and buyers trade patents as “commodities” on the patent operation platform to realize transfer of patent rights.

However, in practical applications, patent data are often manually entered into the patent operation platform, and there may be errors in the entry of patent data.

### SUMMARY

In order to avoid errors in the entry of patent data into a patent transaction platform, an objective of the present disclosure is to provide a patent data publishing method and system, and a patent transaction platform.

In order to achieve the above objective, the present disclosure provides a patent data publishing method, which is applied to a patent transaction platform, and includes the following steps:

providing at least one piece of bibliographic data of a patent to be transacted; acquiring and verifying, based on the at least one piece of bibliographic data, all bibliographic data and a legal status of the patent to be transacted; acquiring a transaction price of the patent to be transacted; and publishing the transaction price, all the bibliographic data, and the legal status.

Preferably, the acquiring a transaction price of the patent to be transacted may include: acquiring the transaction price of the patent to be transacted based on a patent value evaluation model.

Preferably, the acquiring a transaction price of the patent to be transacted may include: acquiring the transaction price of the patent to be transacted based on a publisher's definition.

Preferably, the providing at least one piece of bibliographic data of a patent to be transacted specifically may include: providing the at least one piece of bibliographic data of the patent to be transacted, such as patent title, patent number, publication number or patent owner.

Preferably, the acquiring, based on the at least one piece of bibliographic data, all bibliographic data and a legal status of the patent to be transacted may include: linking, based on the at least one piece of bibliographic data, a third-party patent data platform to acquire all the bibliographic data and the legal status of the patent to be transacted.

Compared with the prior art, in the present disclosure, all the bibliographic data and legal status of the patent to be transacted can be acquired on the patent transaction platform by entering at least one piece of bibliographic data, avoiding the problem of incorrect manual entry. Besides, the present disclosure further avoids incorrect entry by verifying all the bibliographic data and legal status of the patent to be transacted. In addition, the present disclosure can improve the efficiency of entry for a large number of patents to be transacted.

The present disclosure further provides a patent data publishing system, including: a transceiving unit, configured to provide at least one piece of bibliographic data of a patent to be transacted; a processing unit, configured to acquire and verify, based on the at least one piece of bibliographic data, all bibliographic data and a legal status of the patent to be transacted; an acquisition unit, configured to acquire a transaction price of the patent to be transacted; and a publishing unit, configured to publish the transaction price, all the bibliographic data, and the legal status.

Preferably, the acquisition unit may be specifically configured to: acquire the transaction price of the patent to be transacted based on a patent value evaluation model or a publisher's definition.

Preferably, the transceiving unit may be specifically configured to: provide the at least one piece of bibliographic data of the patent to be transacted, such as patent title, patent number, publication number or patent owner.

Preferably, the processing unit may be specifically configured to: link, based on the at least one piece of bibliographic data, a third-party patent data platform to acquire all the bibliographic data and the legal status of the patent to be transacted.

Compared with the prior art, the patent data publishing system of the present disclosure has the same beneficial effects as the patent data publishing method, which will not be repeated herein.

The present disclosure further provides a patent transaction platform, including the patent data publishing system.

Compared with the prior art, the patent transaction platform of the present disclosure has the same beneficial effects as the patent data publishing method, which will not be repeated herein.

### BRIEF DESCRIPTION OF THE DRAWINGS

FIG. 1 is a flowchart of a patent data publishing method according to the present disclosure; and

FIG. 2 is a structural block diagram of a patent data publishing system according to the present disclosure.

### REFERENCE NUMERALS

11. transceiving unit; 12. processing unit; 13. acquisition unit; and 14. publishing unit.

### DETAILED DESCRIPTION OF THE EMBODIMENTS

The technical solutions in the embodiments of the present disclosure are described clearly and completely below with reference to the drawings in the embodiments of the present disclosure. Apparently, the described embodiments are merely a part rather than all of the embodiments of the present disclosure. All other embodiments obtained by those of ordinary skill in the art based on the embodiments of the present disclosure without creative efforts should fall within the protection scope of the present disclosure.

In the embodiments of the present disclosure, “multiple” means two or more. The term “and/or” describes associations between associated objects, and it indicates three types of relationships. For example, “A and/or B” may indicate A alone, A and B, or B alone. The terms such as “exemplary” or “such as” are intended to denote an example, illustration, or description so as to present the relevant concept in a particular manner, and should not be construed as preferred or advantageous over other embodiments or designs.

At present, patent operation or transaction platforms, where patents are traded as commodities, are constantly emerging. The existing patent operation or transaction platform requires the patent seller to manually enter the patent's bibliographic data and legal status. Due to the large amount of bibliographic data and legal status, it is inevitable that there may be an error occurring during manual entry.

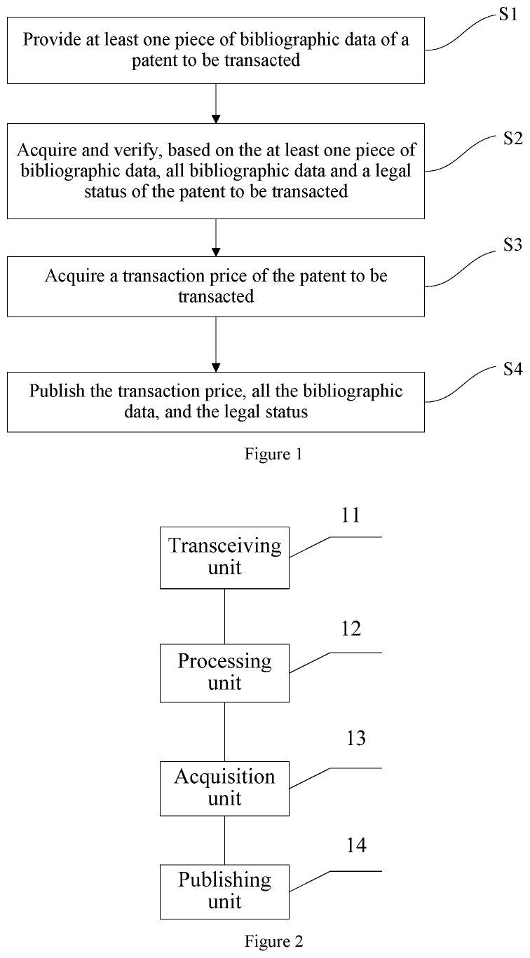

In order to solve the above technical problem, the present disclosure provides a patent data publishing method, as shown in FIG. 1.

The patent data publishing method is applied to a patent transaction platform, and includes the following steps:

S1. Provide at least one piece of bibliographic data of a patent to be transacted.

It should be noted that the patent transaction platform provides a patent transaction channel for a patent seller and a patent buyer. The patent seller and the patent buyer are users of the patent transaction platform, and the user information of the patent seller and the patent buyer is stored on the patent transaction platform. The user information includes at least the names of the patent seller and patent buyer. The patent seller sells a patent, and the patent buyer buys a patent. When a patent to be transacted is published on the patent transaction platform, it is necessary to publish the data of the patent, including bibliographic data and legal status, in as much detail as possible.

As a possible implementation, the patent seller provides at least one piece of bibliographic data of the patent to be transacted, through which the patent can be identified in a patent collection.

S2. Acquire and verify, based on the at least one piece of bibliographic data, all bibliographic data and a legal status of the patent to be transacted.

It should be noted that the above step specifically includes: link, based on the at least one piece of bibliographic data, the patent collection to acquire all the bibliographic data and legal status of the patent. It should be understood that the patent collection may be a local patent collection or a non-local patent collection. For example, it may be a third-party patent website from which all the bibliographic data and legal status of the patent can be acquired. Preferably, the third-party patent website is linked to acquire the bibliographic data and legal status of the patent.

The bibliographic data and legal status of the patent is checked by verifying the identity of the patent owner, so as to determine whether the patent to be transacted is consistent with the information registered by the patent seller on the patent transaction platform. If yes, it means that the patent seller is the real owner of the patent and the transaction can be continued. Otherwise, the patent to be transacted cannot be uploaded to the patent transaction platform.

S3. Acquire a transaction price of the patent to be transacted.

S4. Publish the transaction price, all the bibliographic data, and the legal status.

The bibliographic data, the legal status and the transaction price of the patent to be transacted are displayed on the patent transaction platform.

With the above technical solution, all the bibliographic data and legal status of the patent to be transacted can be acquired on the patent transaction platform by entering at least one piece of bibliographic data, avoiding the problem of incorrect manual entry. Besides, the present disclosure further avoids incorrect entry by verifying all the bibliographic data and legal status of the patent to be transacted. In addition, the present disclosure can improve the efficiency of entry for a large number of patents to be transacted.

Based on the above embodiment, further, the acquiring a transaction price of the patent to be transacted includes: acquire the transaction price of the patent to be transacted based on a patent value evaluation model.

It should be noted that the patent value evaluation model may be one set on the patent transaction platform. The patent seller may choose to conduct the value evaluation of the patent to be transacted on the patent transaction platform so as to acquire the transaction price of the patent to be transacted. The patent value evaluation model may evaluate the transaction price of the patent to be transacted by using any one of a cost method, a market method or an income method.

Based on the above embodiment, further, the acquiring a transaction price of the patent to be transacted includes: acquire the transaction price of the patent to be transacted based on a publisher's definition.

In this embodiment, the patent seller may acquire the transaction price of the patent to be transacted by evaluating the patent to be transacted itself. The patent seller may also determine the transaction price of the patent to be transacted according to a local patent value evaluation model.

Based on the above embodiment, further, the providing at least one piece of bibliographic data of a patent to be transacted specifically includes: provide the at least one piece of bibliographic data of the patent to be transacted, such as patent title, patent number, publication number or patent owner.

With the technical solution, when the bibliographic data is patent number or publication number, the patent to be transacted can be uniquely identified in the patent collection, and all the bibliographic data and legal status of the patent can be acquired by linking to the patent collection. When the bibliographic data is patent title or patent owner, the matching of the patent data can be realized by checking. For example, when the bibliographic data provided by the patent seller is patent title, if a patent with the same title appears in the patent collection, other bibliographic data are reviewed to ensure the authenticity of the patent.

Based on the above embodiment, further, the acquiring, based on the at least one piece of bibliographic data, all bibliographic data and a legal status of the patent to be transacted includes: link, based on the at least one piece of bibliographic data, a third-party patent data platform to acquire all the bibliographic data and the legal status of the patent to be transacted.

As shown in FIG. 2, the present disclosure further provides a patent data publishing system, including: a transceiving unit 11, configured to provide at least one piece of bibliographic data of a patent to be transacted; a processing unit 12, configured to acquire and verify, based on the at least one piece of bibliographic data, all bibliographic data and a legal status of the patent to be transacted; an acquisition unit 13, configured to acquire a transaction price of the patent to be transacted; and a publishing unit 14, configured to publish the transaction price, all the bibliographic data, and the legal status.

Based on the above embodiment, further, the acquisition unit 13 is specifically configured to: acquire the transaction price of the patent to be transacted based on a patent value evaluation model or a publisher's definition.

Based on the above embodiment, further, the transceiving unit 11 is specifically configured to: provide the at least one piece of bibliographic data of the patent to be transacted, such as patent title, patent number, publication number or patent owner.

Based on the above embodiment, further, the processing unit 12 is specifically configured to: link, based on the at least one piece of bibliographic data, a third-party patent data platform to acquire all the bibliographic data and the legal status of the patent to be transacted.

The present disclosure further provides a patent transaction platform, including the patent data publishing system.

The above-mentioned embodiments are merely intended to describe the preferred implementations of the present disclosure, rather than to limit the concept and scope of the present disclosure. Various modifications and improvements made by those of ordinary skill in the art to the technical solutions of the present disclosure without departing from the design concept of the present disclosure should fall within the protection scope of the present disclosure. The technical content claimed by the present disclosure is fully recorded in the claims.

1. A patent data publishing method, applied to a patent transaction platform, and comprising the following steps:
providing at least one piece of bibliographic data of a patent to be transacted;
acquiring and verifying, based on the at least one piece of bibliographic data, all bibliographic data and a legal status of the patent to be transacted;
acquiring a transaction price of the patent to be transacted; and
publishing the transaction price, all the bibliographic data, and the legal status.

2. The patent data publishing method according to claim 1, wherein the acquiring a transaction price of the patent to be transacted comprises:
acquiring the transaction price of the patent to be transacted based on a patent value evaluation model.

3. The patent data publishing method according to claim 1, wherein the acquiring a transaction price of the patent to be transacted comprises:
acquiring the transaction price of the patent to be transacted based on a publisher's definition.

4. The patent data publishing method according to claim 1, wherein the providing at least one piece of bibliographic data of a patent to be transacted comprises:
providing the at least one piece of bibliographic data of the patent to be transacted, such as patent title, patent number, publication number or patent owner.

5. The patent data publishing method according to claim 1, wherein the acquiring, based on the at least one piece of bibliographic data, all bibliographic data and a legal status of the patent to be transacted comprises:
linking, based on the at least one piece of bibliographic data, a third-party patent data platform to acquire all the bibliographic data and the legal status of the patent to be transacted.

6. A patent data publishing system for applying to a patent transaction platform, comprising:
a transceiving unit, configured to provide at least one piece of bibliographic data of a patent to be transacted;
a processing unit, configured to acquire and verify, based on the at least one piece of bibliographic data, all bibliographic data and a legal status of the patent to be transacted;
an acquisition unit, configured to acquire a transaction price of the patent to be transacted; and
a publishing unit, configured to publish the transaction price, all the bibliographic data, and the legal status.

7. The patent data publishing system according to claim 6, wherein the acquisition unit is specifically configured to: acquire the transaction price of the patent to be transacted based on a patent value evaluation model;
or
acquire the transaction price of the patent to be transacted based on a publisher's definition.

8. The patent data publishing system according to claim 6, wherein the transceiving unit is specifically configured to:
provide the at least one piece of bibliographic data of the patent to be transacted, such as patent title, patent number, publication number or patent owner.

9. The patent data publishing system according to claim 6, wherein the processing unit is specifically configured to:
link, based on the at least one piece of bibliographic data, a third-party patent data platform to acquire all the bibliographic data and the legal status of the patent to be transacted.

10. A patent transaction platform, comprising a patent data publishing system, and the patent data publishing system comprising:
a transceiving unit, configured to provide at least one piece of bibliographic data of a patent to be transacted;
a processing unit, configured to acquire and verify, based on the at least one piece of bibliographic data, all bibliographic data and a legal status of the patent to be transacted;
an acquisition unit, configured to acquire a transaction price of the patent to be transacted; and
a publishing unit, configured to publish the transaction price, all the bibliographic data, and the legal status.
